(19) United States
(12) Patent Application Publication
(10) Pub. No.: US 2005/0286108 A1
(43) Pub. Date: Dec. 29, 2005

(54) Ultrafast optical delay lines using a time-prism pair

(76) Inventors: Chris Xu, Ithaca, NY (US); James va Howe, Cortland, NY (US)

Correspondence Address: JONES, TULLAR & COOPER, P.C., P.O. BOX 2266 EADS STATION, ARLINGTON, VA, 22202, US

(21) Appl. No.: 11/123,224

(22) Filed: May 6, 2005

Related U.S. Application Data
(60) Provisional application No. 60/568,222, filed on May 6, 2004.

(51) Int. Cl. G02F 1/23

(52) U.S. Cl. 359/278

(57) ABSTRACT

A programmable, ultrafast optical delay line based on reversible frequency conversion uses a time-prism pair and no moving parts. A first electro-optic phase modulator acting as a first time-prism shifts the frequency of an incoming pulse train. The pulse train passes through a dispersion element, such as a dispersive fiber, which delays the pulse train by an amount that is directly proportional to the magnitude of the frequency shift, which in turn is proportional to the magnitude of the phase modulator drive voltage. A second electro-optic phase modulator is driven π out of phase to the first modulator and restores the frequency of the delayed pulse train to the original frequency of the incoming pulse train. To reduce pulse broadening effects and enhance performance further, soliton propagation inducing elements can be employed between the time-prisms.

### CROSS REFERENCE TO RELATED APPLICATIONS

This application claims the benefit, under 35 U.S.C. 119(e), of U.S. Provisional Application No. 60/568,222, filed May 6, 2004, which is herby incorporated by reference.

### BACKGROUND OF THE INVENTION

1. Field of the Invention

The present invention relates in general to an optical delay line that employs reversible frequency conversion using a pair of time-prisms and a dispersion element for imparting a delay to an optical pulse train.

2. Description of the Background Art

Optical delay lines with programmable delays, fine resolution and rapid scanning are necessary for a variety of applications such as optical coherence tomography, optical metrology, interferometry, broadband phase arrays and telecommunications. As these technologies continue to improve, there is a need for optical delay lines with faster and faster scanning. Techniques with the fastest scanning include the use of acousto-optic modulators or deflectors to achieve scanning rates on the order of 1 MHz. Other techniques make use of grating-based dispersive optics and scanning mirrors to obtain scanning rates on the order of 1 kHz. However, a need remains for optical delay lines that are capable of scanning at much higher rates of speed.

### SUMMARY OF THE INVENTION

The present invention relates to a programmable, ultrafast optical delay line that can achieve record scanning rates of 0.5 GHz. The optical delay line is based upon the principle of frequency conversion through electro-optic phase modulation and employs what are referred to as time-prisms for this purpose. A time-prism works by converting the frequency of an incoming electric field. This is analogous to a spatial prism pair which changes the \vec{k} vector of the incoming field, resulting in a displacement in space. Mathematically, a time-prism imposes a linear phase in time onto an incoming E-field, just as a spatial prism does so in space. A second time prism can then be used to shift the frequency of the field back to its original value.

In the preferred embodiments, a first phase modulator is employed that acts as a first time prism and shifts the frequency of an incoming pulse train by an amount that is proportional to a drive voltage. The frequency shifted pulse train is then fed though a dispersion element, which imparts a delay to the pulse train, the magnitude of which is proportional to the magnitude of the frequency shift and is therefore also proportional to the magnitude of the modulator drive voltage. Tuning the drive voltage of the time-prism is analogous to changing the apex angle of a spatial prism. In either case, one changes the phase slope, thereby changing the frequency (\vec{k} vector), and hence the delay (spatial translation). Finally, the pulse train is fed through a second phase modulator that is driven with the same sinusoid, but π out of phase to the first time prism. This acts as a second time prism and shifts the frequency of the pulse train back to its original frequency. In the foregoing manner, the delay imparted to the pulse train is programmable by adjusting the drive voltage that is applied to the time-prisms or phase modulators.

In the preferred embodiments, sinusoidally driven LiNbO₃ phase modulators are employed as the time prisms and a dispersion fiber of known length and characteristics is employed as the dispersion element, thus resulting in an all-fiber delay line. In one preferred embodiment of the invention, soliton propagation is employed between the time-prisms to avoid input pulse broadening effects that occur when linear propagation is employed. In linear propagation, because the temporal width of the broadened pulse must not exceed the finite linear portion of the frequency-shifting phase profiles, the delay-to-pulse-width ratio is somewhat limited, even after careful optimization between dispersion, modulation frequency and input pulse width. Use of soliton propagation between the time-prisms eliminates this broadening effect and notably increases the delay-to-pulse width ratio.

### BRIEF DESCRIPTION OF DRAWINGS

The various features and advantages of the invention will become apparent to those of skill in the art from the following description, taken with the accompanying drawings, in which:

FIG. 1 is a schematic illustration of the key fundamental elements of the preferred embodiments of the present invention;

FIG. 2A is a schematic representation of a spatial prism analogy to the time-prism theory employed in the present invention;

FIG. 2B is a schematic illustration of a first preferred embodiment of the invention and an experimental setup to test the same;

FIG. 3A is another schematic representation of a spatial prism analogy to the time-prism theory employed in the present invention; and

FIG. 3B is a schematic illustration of a second preferred embodiment of the invention and an experimental setup to test the same.

### DETAILED DESCRIPTION OF THE PREFERRED EMBODIMENTS

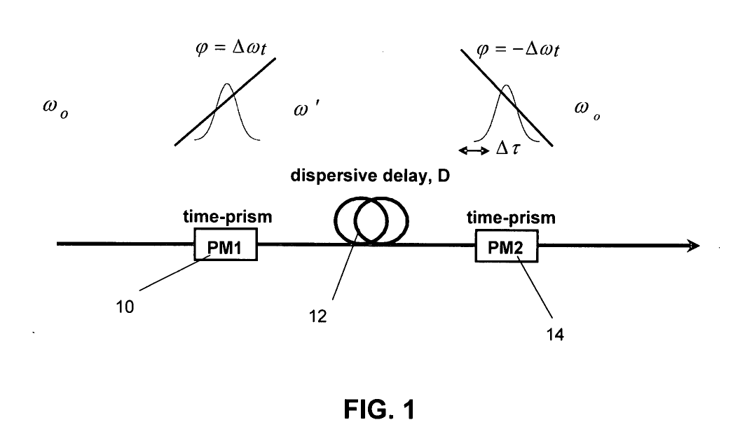

With reference now to a more detailed description of a number of preferred embodiments of the present invention, FIG. 1 is a schematic illustration of the key fundamental elements that are present in all embodiments of the present invention. An incoming pulse train of know frequency co is input to a first phase modulator 10, which acts as a first time-prism and shifts the frequency of the incoming pulse train by an amount that is proportional to a drive voltage that is applied to the phase modulator 10. The pulse train now has a frequency ω′ and is fed through a dispersion element 12, which, depending on the embodiment of the invention employed, can be a dispersion fiber such as single mode fiber (SMF) or dispersion compensating fiber (DCF), a Fiber Bragg Grating (FBG), a grating pair or any other suitable dispersion element in order to impart a delay to the frequency shifted pulse train as it passes there through. Finally, the delayed pulse train passes through a second phase modulator 14 which acts as a second time-prism and shifts the frequency back to its original frequency ω₀.

The key operational feature of this arrangement is that the amount of the delay imparted by the dispersion element 12 is directly proportional to the amount by which the frequency of the pulse train has been shifted by the first phase modulator 10. Since this is in turn proportional to the drive voltage applied to the phase modulator 10, the amount of delay imparted to the pulse train is easily programmable simply by controlling the phase modulator drive voltage.

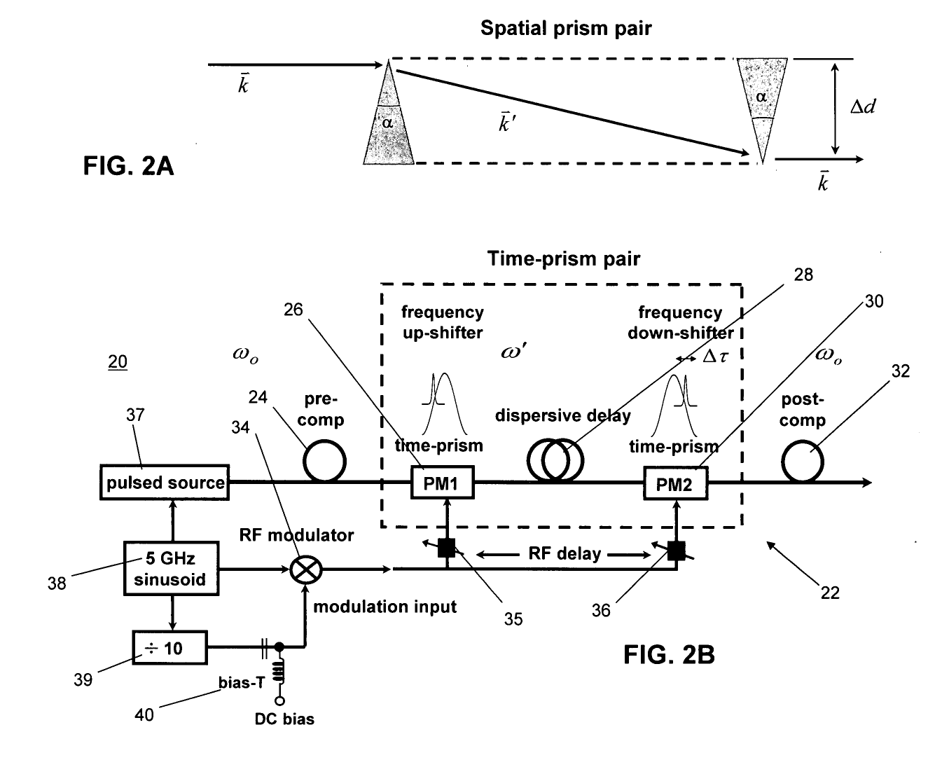

Turning now to an in depth analysis of the theory by which the invention works, a time-prism works by converting the frequency of an incoming electric field. Any amount of dispersion following the prism results in a displacement of the electric field in time. Another time-prism can be used to convert the frequency back to its original value, with the resultant field being the original electric field, but delayed in time. This is analogous to a spatial prism pair as illustrated in FIG. 2A in which changes the \vec{k} vector of the incoming field, resulting in a displacement in space. The second prism can be used to convert the \vec{k} vector back to its original value, with the resultant field being the original electric field translated in space. Mathematically, a time-prism imposes a linear phase in time onto an incoming E-field, just as a spatial prism does so in space. The subject method utilizes a sinusoidally driven phase modulator to achieve the following phase profile:

$$φ = π \frac{V}{2 {V}_{π}} sin ( 2 π {f}_{m} t ) \approx {π}^{2} \frac{V}{{V}_{π}} {f}_{m} t . \qquad ( 1 )$$

Here the sine term has been expanded to first order where fₘ is the modulation frequency, V is the peak-to-peak drive voltage, and V_{π} is the voltage required to obtain a π phase shift. The frequency of the incoming optical field is therefore shifted by an amount

$$Δ ω = \frac{ⅆ φ}{ⅆ t} = {π}^{2} \frac{V}{{V}_{π}} {f}_{m} .$$

Using a fiber of dispersion value D (ps/nm) after a time-prism introduces a delay

$$Δτ = Δλ D = π \frac{{λ}^{2}}{2 c} \frac{V}{{V}_{π}} {f}_{m} D , \qquad ( 2 )$$

where λ is the center wavelength of the incident pulse train, and

$$Δλ = \frac{{λ}^{2}}{2 π c} Δω ,$$

is the corresponding wavelength shift due to phase modulation. Tuning the drive voltage of the time-prism is analogous to changing the apex angle of a spatial prism. In either case, one changes the phase slope, thereby changing the frequency (\vec{k} vector), and hence the delay (spatial translation). To convert the frequency of the optical field back to its original value, one need only impose a phase—Δωt, which can be easily accomplished by another phase modulator driven with the same sinusoid, but π out of phase.

Turning now to FIG. 2B, the details of an experimental setup 20 that was employed to evaluate a pulse delay 22 comprising a first preferred embodiment of the invention are illustrated. The elements of the pulse delay 22 include a pre-compensation dispersive fiber spool 24, a first LiNbO₃ phase modulator 26, a dispersion delay element 28, a second LiNbO₃ phase modulator 30 and a post-compensation dispersive fiber spool 32. A broadband RF modulator (e.g. Minicircuits; ZMX-7GMH)RF modulator 34 supplies a controllable drive voltage to the first and second phase modulators 26 and 30 to control the amount of delay imparted to a pulse train. The RF modulator output is fed to the phase modulators 26 and 30 through first and second variable RF delays 35 and 36, respectfully. The variable RF delays 35 and 36 ensure the proper positioning of the optical pulse with respect to the drive voltages at the phase modulators 26 and 30.

During the experiment, the pulse delay 22 was supplied pulses from a pulsed laser source 37. The laser source 37 generated an 8-ps pulse train at 5 GHz repetition rate by pulse-carving CW light and time-lens compression. After the pulse train passes through the pre-compensation dispersive fiber spool 24, it is input to the first LiNbO₃ phase modulator 26 (PM1) that acts as the first time-prism and up-shifts the frequency of the incoming pulse train. A sinusoidal generator 38 supplied a 5 GHz sine wave to the RF modulator 34, which generates a modulated output drive voltage for the first and second LiNbO₃ phase modulators 26 and 30. A time delay is then introduced by the dispersion delay element 28, which in the experiment consisted of 0.7 km of DCF (total dispersion value D=−74 ps/nm). The use of DCF is preferred over SMF because DCF provides 5 times the dispersion value of SMF and thus can be made 5 times shorter. However, an FBG would probably be an even better choice for this embodiment because it is a smaller device with even less fiber. The second time-prism, the LiNbO₃ phase modulator 30 (PM2), is driven with the same sinusoid, but π out of phase, and is used to down-shift the frequencies back to their original values. The dispersion pre-compensation (37 ps/nm) and post-compensation (37 ps/nm) spools 24 and 32 are used to eliminate the pulse broadening effects caused by the dispersion delay element 28, and to achieve symmetrical operations for the frequency shifters, thus ensuring pulse delay without the adverse effect of pulse distortion. To vary the frequency shift and therefore the delay, the drive voltage to the phase modulators 26 and 30 is adjusted through the RF modulator 34. The resulting time delay from Eq. (2) is
Δτ=ΔλD∝V∝V_{RF}_{_{—}}_{mod}, (3)
where V_{RF}_{_{—}}_{mod} is the modulation input into the RF modulator. Thus, ultrafast programmable time delays can be obtained by controlling the modulation waveform V_{RF}_{_{—}}_{mod}.

To demonstrate the concept, the 5 GHz RF input was modulated with DC voltages from a frequency divider 39 through a bias-T 40. In the experimental set up, the dependence of the frequency shift and corresponding time delay on the modulation input V_{RF}_{_{—}}_{mod} was measured. A frequency shift of 32.5 GHz was achieved at the highest RF output into the phase modulator (V˜4.24 V_{π}), which resulted in a time-delay of 19 ps. These results agree well with Eq. (2). The ultrafast scanning capability of the delay line was demonstrated by modulating the RF input with a sinusoidal waveform at 0.5 GHz. A resulting excellent match between measurement and theory demonstrated the system's robustness and predictability.

Care was taken in the choosing parameters in the setup to ensure that as much energy as possible of the optical pulses was placed over the linear portion of the electrical sinusoidal drive both for frequency up-shifting and down-shifting, while simultaneously maximizing the amount of time delay. This is important because higher-order terms in the phase modulation drive are responsible for distortions in both the spectral and temporal pulse profile. Any nonlinear modulation terms in the frequency up-shift drive will chirp the pulses and lead to compression or broadening if not unchirped by frequency down-shifting. This unchirping is difficult to apply to every pulse, which will each have different time delays, and will therefore be frequency-downshifted by different portions of the down-shifting sinusoid, some of which are more nonlinear than others. This results in the inability to convert the spectrum of the up-shifted optical field back to the original, and therefore results in variation in pulse intensity, width and shape. The system exhibited small distortions due to this nonlinearity which is evident from an observed 1.0% variation in optical intensity of the delayed pulses. Failure to completely restore the original optical spectrum was observed in the spectrum after frequency down-shifting for the worst case scenario (the case of highest frequency up-shift, 32.5 GHz, corresponding to the highest DC modulation input into the bias-T 40). This incomplete spectral match agreed well with simulations.

The limitation of the nonlinear phase profile can be largely overcome by using an improved drive waveform to the phase modulators. Computer modeling indicated that adding a correction time-prism, analogous to aberration correction in a time-lens system, can reduce nonlinearity in the phase modulation drive and significantly reduces pulse distortion. Fourier analysis allows any periodic function to be decomposed into a sum of harmonics. In the case of an ideal triangle waveform, the next order term in the Fourier expansion is the third harmonic. Calculations show that maximum reduction of the pulse distortion can be achieved by adding a sinusoidal drive at 15 GHz and a peak-to-peak amplitude of 0.29 V_{π} (three times the frequency of the original time-prism and 6.9% of the drive). On the other hand, for spectral distortion comparable to that of the uncorrected system, the additional correction time-prism was found to increase the total delay to 28 ps. In terms of the initial pulse width Tₒ=8.0 ps, the correction prism extended the delay range from 2.4Tₒ to 3.5Tₒ. It should be noted that instead of a separate correction time-prism stage, it is possible to implement this correction technique by combining both the 5 GHz and 15 GHz drives into a single RF drive, and therefore using a single phase modulator to obtain the same results.

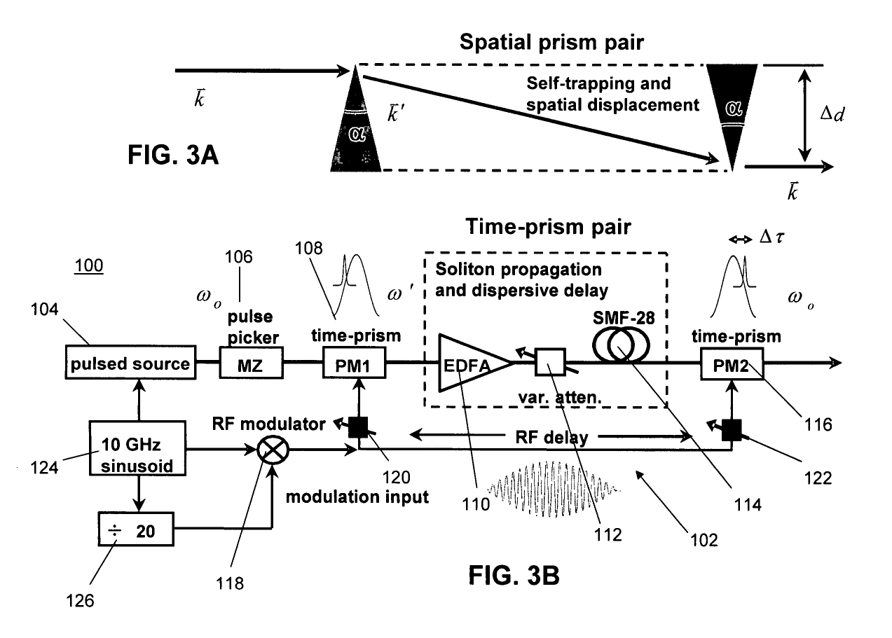

Turning now to a second preferred embodiment of the present invention, FIG. 3B illustrates an experimental setup for testing this embodiment, which differs from the embodiment of FIG. 2B primarily in its usage of elements that ensure soliton propagation between the time-prisms. One fundamental limitation in the first preferred embodiment is that the dispersion used to obtain the necessary time delay also inevitably broadens the input pulse. Because the temporal width of the broadened pulse must not exceed the finite linear portion of the frequency-shifting phase profiles, the delay-to-pulse-width ratio of first preferred embodiment was limited to 2.4, even after careful optimization between dispersion, modulation frequency and input pulse width. To overcome this limitation, one needs a scheme to produce a dispersive delay without dispersive pulse broadening. The second, preferred embodiment of the present invention provides such a scheme by using soliton propagation between time-prisms.

A soliton is a self-reinforcing solitary wave caused by nonlinear effects in the medium. In the present invention, an example of a soliton is a laser pulse that retains its shape in the dispersion fiber over long distances, does not obey the superposition principle and does not disperse. To take advantage of soliton propagation, the pulse train entering the dispersion fiber from the first time prism must be of the same shape as the pulse train exiting the dispersion fiber. In this embodiment, the power of the input pulse is adjustable through use of an amplifier or the like. The power is adjusted until the soliton propagation condition is satisfied at which point the shape of the output pulse train matches that of the input pulse train. Through theoretical analysis, the fundamental relationships between the delay-to-pulse-width ratio and the input pulse width were derived to show the enhanced performance using soliton propagation.

The figure of merit for any delay line is the delay-to-pulse-width ratio which can be defined as R=Δτ/T_{FEHM}, where T_{FWHM} is the intensity full width at half maximum for the input pulse and Δτ is the maximum time delay at the output of the device, given by [5] as

Here Δλ is the wavelength shift imparted by the linear portion of the sinusoidal phase modulation drive, and D is the dispersion in ps/nm. This wavelength shift is determined by Vₚ₋ₚ, V_{π}, and Tₘ which are respectively the peak-to-peak drive voltage into the phase

$$Δτ = Δλ \cdot D = ( {π}^{2} \frac{{λ}^{2}}{2 π c} \frac{{V}_{p - p}}{{V}_{π}} \frac{1}{{T}_{m}} ) \cdot D . \qquad ( 3 )$$

modulators, the voltage required to obtain a π phase shift, and the modulation period. For simplicity, assume the input pulse has a Gaussian temporal profile and is chirp free in the following analysis. In the first preferred embodiment of the invention illustrated in FIG. 2B, pre- and post-dispersion compensation are used in order to restore the original optical pulse width at the end of the device and to ensure symmetric operation of the time-prisms. The optical pulse width at each phase modulator is therefore broadened from the original input pulse by an amount

$$σ = \sqrt{1 + {( \frac{{λ}^{2}}{2 π c} \frac{D}{2 {T}_{o}^{2}} )}^{2}} , \qquad ( 4 )$$

where Tₒ is the intensity 1/e half-width of the Gaussian input pulse. In order to have complete reversible frequency conversion, the broadened pulse plus the full delay is restricted to the linear portion (T_{Lin}) of the sinusoidal modulation drive,
Tₒσ+Δτ<T_{Lin.} (5)

The linear portion of the modulation drive depends on the fractional nonlinearity that can be tolerated in an experiment. Here, the fractional nonlinearity, NL, is defined as the ratio of the cubic term to the linear term in the Taylor expansion of the sinusoidal modulation. The fractional nonlinearity determines the amount of spectral and temporal distortion of output pulses and the linear portion for a given NL can be solved as T_{Lin}=βTₘ, where

$$β = \frac{2}{π} \sqrt{( 1.5 ) N L} .$$

Eq.'s (3-5) are used to solve for the delay-to-pulse-width ratio, R, as a function of input pulse width for linear and soliton propagation. In the linear propagation regime, dispersive pulse broadening dominates for short pulses where the optical pulse bandwidth (Δλₒₚₜ) is much greater than the wavelength shift produced by the phase modulator, i.e., Δλₒₚₜ>>Δλ. The asymptotic behavior for short pulses at a given NL approaches

$$R = {π}^{2} \frac{{V}_{p - p}}{{V}_{π}} {\frac{β}{\sqrt{ln 2}} [ 1 + 2 {π}^{2} \frac{{V}_{p - p}}{{V}_{π}} \frac{{T}_{o}}{{T}_{m}} ]}^{- 1} . \qquad ( 6 )$$

For long input pulse widths, Δλₒₚₜ<<Δλ, pulse broadening is negligible (σ→l) and the asymptotic behavior for long pulses approaches

$$R = \frac{1}{2 \sqrt{ln 2}} ( \frac{β {T}_{m}}{{T}_{o}} - 1 ) , \qquad ( 7 )$$

reaching zero for Tₒ=βTₘ, the maximum input pulse width allowed for a given NL. For soliton propagation between time-prisms, however, dispersive pulse broadening is completely balanced by self-phase modulation, i.e., σ=1 in Eq. (5). Thus, the expression for R at any pulse width is given by Eq. (7). Although linear and solitonic propagation are the same in the long pulse limit, soliton propagation is far superior for short pulses, eliminating the finite limit on R at short pulse widths. The enhanced ratio using soliton propagation between time-prisms can be understood intuitively in terms the spatial analogy illustrated in FIG. 3A. It is well known that the analog to narrow-band dispersion in the time domain is paraxial diffraction in space. Here, this spatial-temporal analogy is further extended to include optical nonlinearity, where soliton propagation is just the temporal analog of spatial self-trapping. In the absence of self-trapping between a spatial prism pair (linear propagation), the spatially translated beam is also expanded by diffraction, requiring a balance between the input beam diameter and prism separation in order to have successful \vec{k} vector conversion. Compensating diffraction with self-focusing eliminates such a constraint and therefore improves performance.

An experimental setup 100 for a soliton propagation-based pulse delay 102 is shown in FIG. 3B. It should be noted that many of the elements are the same as in the first preferred embodiment. In this set up, a pulsed source 104 (e.g. Calmar Optcom; PSL-10) emits a 5.5 ps FWHM (3 dB bandwidth ˜0.48 nm), chirp-free, 10 GHz pulse train at a center wavelength of 1549.3 mm. The pulse train is divided down to a 5 GHz repetition rate using a Mach-Zehnder LiNbO₃ modulator as a pulse picker 106. The carrier wavelength of the pulse train is then up-shifted by a time-prism, a 10 GHz sinusoidally driven LiNbO₃ phase modulator (PM1) 108. An erbium doped fiber amplifier (EDFA) 110 and a variable attenuator 112 are used to adjust the optical power to satisfy the soliton condition for propagation in the following 2.88 km of SMF-28 fiber 114 (total dispersion 49 ps/nm). Although standard SMF was used to achieve the dispersive delay in the experiment, other fiber types, such as those with much smaller mode field diameters can be used to reduce the power requirement for solitons, making the technique applicable for a sub-picosecond pulse train. However, it should be noted that this embodiment of the invention cannot be used with other types of dispersion elements such as FBGs and grating pairs.

After propagating as a soliton pulse train through the dispersive delay 114, the carrier wavelength is down-shifted back to its original value by a second time-prism (PM2) 116, driven with the same sine wave, but π out of phase. As is the previous embodiment, the amount of wavelength shift, and therefore the amount of time delay, is controlled by adjusting the drive voltage into the phase modulators 108 and 116 through a broadband RF modulator 118 (such as a Miteq; BMA0218LA1MD) feeding a drive voltage through first and second variable RF delays 120 and 122. The RF modulator receives a 10 GHz signal from a sinusoid 124 and modulates the same with a modulation input from a divider 126. Since Vₚ₋ₚ∝V_{RF}_{_{—}}_{mod}, where V_{RF}_{_{—}}_{mod} is the modulation input into the RF modulator 118, Δτ becomes a function of V_{RF}_{_{—}}_{mod}, Eq. (1). Thus, ultrafast programmable time delays can be obtained by controlling the modulation waveform V_{RF}_{_{—}}_{mod}.

To demonstrate the concept, soliton propagation was first verified by showing that for the proper input power, the spectrum and the pulse remain unchanged after propagating through the 2.88 km of fiber. To demonstrate the ultrafast scanning capability of the delay line and the improved performance using soliton propagation, a 10 GHz RF sine wave was modulated with a 0.5 GHz sinusoid. The maximum RF output into the wavelength up-shifting phase modulator was approximately 5.24 V_{π}, corresponding to a maximum wavelength shift of 0.66 nm.

By using soliton propagation between time-prisms, dispersive broadening no longer occurs, gaining an additional 10 ps in time delay for this particular experimental setup. The improved performance was demonstrated by the excellent match between the original soliton spectrum and the spectrum after wavelength down-shifting.

Scanning of the optical delay in the soliton propagation regime was evaluated. The results demonstrated the precise mapping of the modulation input to the time delay. Here the measured maximum time delay was found to be 33.0 ps, giving a delay-to-pulse-width ratio of 6.0. This matches well to what is expected given the 0.66 nm wavelength shift and 49 ps/nm dispersion. While additional measurements on the spectral phase will uniquely match the pulse shape before and after the delay, the nearly identical pulse spectra and time traces are very good indications that the output pulse train is simply a delayed replica of the input.

In summary, experiments have confirmed that the subject pulse delay can scan at frequencies of up to 0.5 GHz, which is on the order of 1000 times faster than any known pulse delays. This fact, combined with the fact that the delay employs no moving parts and can be constructed entirely from optical fibers, makes the delay particularly attractive from a commercial standpoint.

Although the invention has been disclosed in terms of preferred embodiments and variations thereon, it will be understood that other variations and modifications could be made thereto without departing from the scope of the invention as defined in the following claims.

1. A programmable, ultrafast optical delay line, comprising:
a first optical phase modulator acting as a first time prism for converting a frequency of an incoming pulse train from a first frequency to a second frequency;
a dispersion element for imparting a delay to the frequency converted pulse train;
a second optical phase modulator acting as a second time prism for converting the frequency of said delayed pulse train back to said first frequency; and
a delay controller for controlling the amount of delay imparted to said pulse train by said dispersion element, said delay controller comprising a controllable source of drive voltage for said first and second phase modulators which applies a drive voltage to said first phase modulator having a magnitude that is directly proportional to the magnitude of a difference between said second frequency and said first frequency.
